(19) United States
(12) Patent Application Publication
(10) Pub. No.: US 2025/0138909 A1
(43) Pub. Date: May 1, 2025

(54) Resource-Efficient and Time-Efficient Prompting of a Language Model to Invoke Functions

(71) Applicant: Microsoft Technology Licensing, LLC, Redmond, WA (US)

(72) Inventors: Girish Milind MAHAJAN, Redmond, WA (US); Sayan Dev PATHAK, Kirkland, WA (US); Michael Anthony TAYLOR, Kirkland, WA (US); Salman Mohammad QUAZI, Mountain View, CA (US); Christopher Hakan BASOGLU, Everett, WA (US); Prashanth SRIKANTHAN, Seattle, WA (US)

(73) Assignee: Microsoft Technology Licensing, LLC, Redmond, WA (US)

(21) Appl. No.: 18/401,060

(22) Filed: Dec. 29, 2023

Related U.S. Application Data
(60) Provisional application No. 63/546,599, filed on Oct. 31, 2023.

(51) Int. Cl. G06F 9/54; G06N 20/20

(52) U.S. Cl. CPC G06F 9/541; G06N 20/20

(57) ABSTRACT

A technique sends a first prompt to a language model that specifies selector information. The selector information provides a summary of a group of functions that are capable of being invoked. The language model responds by choosing one or more functions from the group of functions. The technique then sends a second prompt to the language model that specifies more detailed information regarding just the function(s) that have been identified by the language model. The language model responds by providing invocation information for each of the functions, such as properly formatted API messages. The technique then invokes the function(s) based on the invocation information. The technique reduces the size of each prompt sent to the language model, which makes efficient use of resources and improves the quality of the language model's output results.

This application claims the benefit of U.S. Provisional Application No. 63/546,599 (the '599 Application), filed on Oct. 31, 2023. The '599 Application is incorporated by reference herein in its entirety.

### BACKGROUND

Some language models are now capable of generating function invocation information, such as a properly-formatted application programming interface (API) messages. An application uses an instance of invocation information to invoke a particular function. This capability, generally referred to in the industry as “function calling,” provides an effective way of integrating the use of language models in applications which perform diverse sets of operations. But this capability is also resource-intensive nature, and sometimes produces erroneous results caused by hallucination by the language model. These problems are particularly pronounced in those environments in which the language model is given the opportunity to interact with a large number of functions.

### SUMMARY

A technique is described herein for sending a first prompt to a language model that specifies a query and selector information. The selector information provides a summary of a group of functions that are capable of being invoked. The language model responds by choosing one or more functions from the group of functions that are best suited to addressing a user's query. The technique then sends a second prompt to the language model that specifies more detailed information regarding just the function(s) that have been identified by the language model. The language model responds by providing invocation information for each of the functions, such as properly formatted API messages. The technique then invokes the function(s) based on the invocation information.

The technique makes efficient use of memory resources and processor resources because it refrains from sending a complete function definition for all of the functions in a library of functions. More specifically, the technique reduces the number of tokens in each prompt it sends to the language model (compared to the example of a prompt that provides a full description of all of the available functions). The language model is able to make more efficient use of memory resources and processor-related resources due to the reduction in the amount of tokens that require storage and processing.

Further, by reducing the number of tokens sent to the language model in each prompt, the technique is able to enhance the language model's ability to focus on the most relevant function-related information. This, in turn, improves the quality of the language model's output results. Stated in the negative, by reducing the number tokens, the technique reduces the amount of informational noise given to the language model in any given submission, which, in turn, reduces the incidence of hallucinations. A language model hallucinates when it provides output results that are not well grounded in the context information that has been fed to it.

Further, in some implementations, the technique automatically removes function-related information from a context store when it is determined, based on one or more triggering factors, that the function-related information is no longer needed. For example, the technique removes an instance of function definition information after its associated function has been invoked. This pruning operation is beneficial because it reduces the size of prompts, which would other increase in length over a session.

Further, the technique provides opportunities for reducing latency in generating a response to a query. The technique accomplishes this goal by using the language model to identify two or more functions that are capable of being executed in parallel. The technique then generates respective instances of invocation information for these functions. The technique then invokes the functions in parallel based on the plural instances of invocation information.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a computing system for invoking functions in a resource-efficient manner using a language model.

FIGS. 2 and 3 together show a first example of the operation of the computing system of FIG. 1.

FIG. 4 shows illustrative implementations of selector information sent to the language model in a first prompt.

FIG. 5 shows an example of function definition information that is sent to the language model when requested.

FIG. 6 shows one implementation of multi-part selector information that includes a hierarchical arrangement of instances of component selector information.

FIG. 7 shows a second example of the operation of the computing system of FIG. 1 that involves parallel processing of functions.

FIG. 8 shows a first approach to obtaining selector information and function definition information.

FIG. 9 shows a second approach to obtaining selector information and function definition information.

FIG. 10 shows one implementation of a context-pruning component, which is part of the computing system of FIG. 1.

FIG. 11 shows an illustrative language model for implementing various functions of the computing system of FIG. 1.

FIG. 12 is a flowchart that provides an overview of one manner of operation of the computing system of FIG. 1.

FIGS. 13 and 14 together show a flowchart that provides another overview of the operation of the computing system of FIG. 1.

FIG. 15 shows computing equipment that, in some implementations, is used to implement the computing system of FIG. 1.

FIG. 16 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview of the Computing System

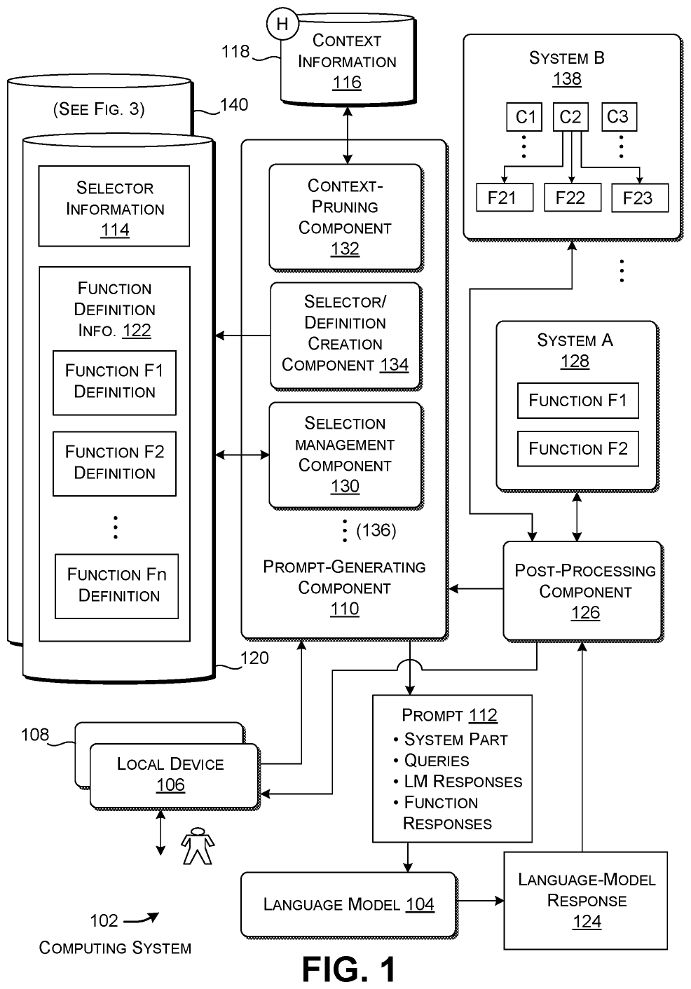

FIG. 1 shows a computing system 102 for using a machine-trained language model (“language model”) 104 in a process of invoking one or more functions. Generally, the computing system 102 sends function-related information to the language model 104 at any given time that is a portion of a more encompassing body of function-related information that could be selected. The computing system 102 reduces the size of each prompt it sends to the language model 104 (compared to the case in which the prompt specifies the full body of function-related information). This has the effect of reducing the amount of memory and processor resources that are required by the language model 104 to process each prompt. This characteristic also improves the quality of output results produced by the computing system 102, e.g., by reducing the amount of noise that is given to the language model 104 in each pass, which, in turn, reduces the incidence of hallucinations. In the present context, the language model 104 hallucinates when it produces inaccurate function invocation information, or chooses to invoke an incorrect or non-optimal function. Other technical merits to the computing system 102 will be identified in the ensuing explanation.

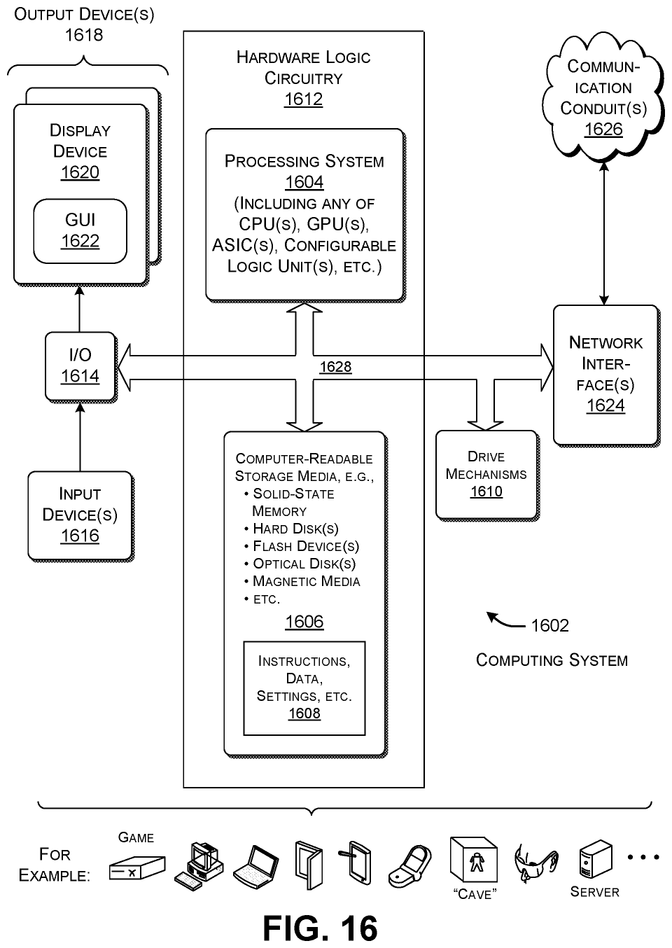

The following terminology is relevant to some examples presented below. A “machine-trained model” or “model” refers to computer-implemented logic for executing a task using machine-trained weights that are produced in a training operation. A “weight” refers to any type of parameter value that is iteratively produced by the training operation. A “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. A “prompt” refers to a sequence of tokens submitted to a machine-trained model. An “embedding” is a distributed vector that represents an information item in a vector space. A “distributed vector,” in turn, expresses the semantic content of an information item by distributing information over its k dimensions. A distributed vector is in contrast to a sparse one-hot vector that allocates particular dimensions of the vector to particular concepts. In some contexts, terms such as “component,” “module,” “engine,” and “tool” refer to parts of computer-based technology that perform respective functions. FIGS. 15 and 16, described below, provide examples of illustrative computing equipment for performing these functions.

In some examples, a “function” is any computer-implemented functionality that accepts an input X, performs any prescribed operation(s) on the input X, and delivers an output Y based on the operation(s). In some examples, the input X and output Y have particular respective formats. In some examples, the computing functionality is implemented by a computer program, a machine-trained model, etc., or any combination thereof. The operations encompass data transformation operations, data retrieval operations, data storage operations, message-sending operations, sensor-reading operations, and so on. An application programming interface (API) is one example of a function. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment.

In some examples, an instance of “function definition information” describes any or all of the input X fed to the function, operation(s) performed by the function's computing functionality, and the output Y provided by the function. In some examples, the function definition information takes the form of a formal specification for a computer program or other system. In some examples, “invocation information” is a message or other signal that is used to invoke the computing functionality, e.g., by providing the input X in a format expected by the function.

The language model 104 shown in FIG. 1 is any type of generative model that is capable of generating new instances of data, given an instance of input data. A generative model is in contrast to a discriminative model that discriminates among two or more instances of data. In some implementations, the language model 104 specifically functions as a pattern completion engine that operates in an auto-regressive manner, token-by-token. That is, the pattern completion engine includes weights that reflect statistical patterns which have been learned by performing training on a typically large collection of training examples. Given a set of input tokens, the pattern completion engine predicts a next token that is most likely to follow the input tokens. The pattern completion engine then appends the predicted token to the end of the sequence of input tokens, to produce an updated set of input tokens, and then repeats its analysis for the updated set of tokens. This process continues until the pattern completion engine predicts a stop token, which is a signal that the auto-regression operation should terminate. In some implementations, the language model 104 of FIG. 1 uses an attention mechanism to perform its predictions. The attention mechanism determines the relevance between pairs of tokens in the set of input tokens. Additional information regarding one illustrative implementation of the language model 104 is set forth below in connection with the explanation of Section F.

In some implementations, the language model 104 primarily processes text-based tokens. In other implementations, the language model 104 is a multi-modal engine that is capable of analyzing different types of content, including any of text, images, audio, video, etc. However, to facilitate explanation, the following explanation will mainly focus on examples in which the language model 104 processes text-based tokens.

In some implementations, all of the functions of the computing system 102 shown in FIG. 1 are implemented in local fashion by one or more local computing devices. Alternatively, or in addition, a server system implements one or more of the functions of the computing system 102. For example, in some implementations, the language model 104 is implemented by a network-accessible system, and at least some of the functions are implemented by one or more network-accessible systems. Further, in some implementations, the computing system 102 as a whole is integrated into a particular application (not shown) of any type, such as a search application, product recommendation system, or ad-serving system.

In some implementations, a local computing device 106 of any type receives a query that is input by user or some other entity. The computing system 102 uses the language model 104 to provide a final response to the query, which is delivered to the user via the local computing device 106. In other cases, any other type of endpoint 108 provides a query to be processed, and receives the final response produced by the computing system 102 based on the query. The other endpoint 108, for instance, corresponds to another application or computing system.

A prompt-generating component 110 constructs a prompt 112 that it sends to the language model 104. The prompt 112 contains different information items depending on the stage at which the prompt 112 is produced. For instance, the prompt-generating component 110 creates a first prompt that concatenates query information (that describes the query) with selector information 114. The selector information 114 instructs the language model 104 to choose one or more functions from a group of available functions. To this end, the selector information 114 includes a digest of each of the available functions. In other implementations, the selector information 114 and the query information are sent in series in different prompts, but whatever prompt is sent last will incorporate the information in the prior prompt.

The prompt-generating component 110 generates a second prompt that concatenates prior context information, the selector information 114, and at least one instance of function definition information. The prior context information 116 describes tokens that have been previously submitted to the language model 104. For instance, some of the context information 116 specifies the tokens that compose the query information submitted to language model 104 in the first prompt. (The figures identify the prior context information 116 using the symbol “H,” which denotes “history”).

Each instance of function definition information describes characteristics of a particular function, such as the input information fed into the particular function and the output information produced by the particular function. In any event, each instance of function definition information is more detailed (and hence contains more tokens compared to a digest of that function provided by the first prompt in the selector information 114). The prompt-generating component 110 decides which instance(s) of function definition information to include in the second prompt based on one or more functions selected by the language model 104 in response to the first prompt.

The prompt-generating component 110 obtains the context information 116 from a context data store 118. The prompt-generating component 110 obtains the selector information 114 and each instance of function definition information from a data store 120. More generally, the data store 120 includes function definition information 122 that represents a compendium of all instances of function definition information for all available functions. The prompt-generating component 110 is generally said to compose each prompt in a targeted or selective manner because it constructs each prompt based on only a portion of the information in the data store 120, rather than specifying all instances of function definition information for all of the functions at the same time. This produces a prompt that is orders of magnitude smaller than a prompt that includes all instances of function definition information.

There are no constraints on the assortment of functions described by the selector information 114. In some examples, at least two functions in the set of functions are capable of being performed independently of each other. Two functions are mutually independent when a first function is able to execute its operations regardless of whether the second function has been executed, and vice versa. In some examples, at least two functions in the set of functions are mutually dependent. A first function is dependent on a second function when the first function requires output information produced by the second function, or otherwise requires the prior execution of the second function. In some examples, at least two functions in the set of functions overlap each other in the sense that these two functions share at least some operations. For example, two functions are provided by two service providers that perform related functions, but in different ways. In some cases, the differences may be relatively minor.

The language model 104 responds to the prompt 112 by generating a language-model response 124. The information contained in the language-model response 124 varies depending on the stage at which it is produced. In response to a first-generated prompt, the language model 104 produces a language-model response that provides identification information that identifies the function(s) it has chosen (if any), selected from a group of functions summarized in the selector information 114. In response to a second-generated prompt, the language model 104 produces a language-model response that includes an instance of invocation information for one or more functions. For example, each instance of invocation information is a properly formatted API message to be sent to a particular function (which constitutes an API). In other examples, the function invocation information specifies a reference to a resource (e.g., a website resource) that is to be activated. The reference, for instance, is a uniform resource locator (URL). In other examples, the function invocation information include control signals that control the operation of any type of device, and so on.

A post-processing component 126 receives and acts on the language-model response 124. For example, in response to the generation of the first prompt, the post-processing component 126 sends identifiers of selected function(s) to the prompt-generating component 110. In response to the generation of the second prompt, the post-processing component 126 forwards each instance of invocation information to a corresponding function. In some implementations, at least one system 128 (referred to in FIG. 1 as “system A”) implements the function. For example, the system 128 represents a network-accessible system that provides a service; that service, in turn, uses various Representational State Transfer (REST) APIs to interact with end users or other applications. Each REST API constitutes a function. Alternatively, the local computing system 106, or any other local device, implements at least some of the functions.

The post-processing component 126 receives function-response information from the system 128, which the system 128 produces in response to executing the function(s). In some cases, the post-processing component 126 generates final output information that is based, at least in part, on the function-response information.

In other cases, the post-processing-component 126 forwards the function-response information to the prompt-generating component 110. The prompt-generating component 110 incorporates the function-response information in the next prompt that it sends to the language model 104. In some examples, the language model 104 produces the final output information based on that prompt. In other cases, the language model 104 collects more information through the execution of one or more other functions, in the manner described above. Generally, the language model 104 provides information in its language-model response 124 which conveys whether the language-model response 124 represents the last-generated language-model response or an intermediary language-model response.

Note that any prompt produced by the computing system 102 describes a subset of the available function information provided in the data store 120. This has at least three advantages over the alternative case in which a single prompt fully describes all of the available functions. First, the computing system 102 produces smaller prompts than the alternative case, and therefore consumes less memory resources and processor resources in the course of executing the language model 104. Smaller prompts also reduce the cost of a session for those cases in which a provider assesses a fee for using the language model 104 based on the number of tokens that are required to express the user's queries. Second, the computing system 102 produces superior accuracy than the alternative case. This is because the smaller size of the prompt (compared to the alternative case) enables the language model 104 to more effectively focus on the tokens in the prompt that have the most relevance to the query. A large prompt that describes a large number of functions has the effect of diluting the significance of the most relevant tokens in the prompt, which, in turn, can cause the language model 104 to produce hallucinations. Third, the computing system 102 is scalable because it allows a developer to incorporate a large number of functions, without consideration of whether two or more functions perform an overlapping set of operations. Nor need the developer organize the functions in any particular manner. This capability stems from the fact that the computing system 102 provides only a limited set of functions at each pass, which reduces the risk that confusion is created in discriminating among different functions. In other words, the computing system 102 operates as a filter by sending only the most applicable function(s) to the language model 104 for a given task, which reduces the needs to manually regulate membership of functions in a candidate set of functions and to manually organize the functions in a particular manner.

In some implementations, the prompt-generating component 110 includes plural subcomponents that perform different tasks that contribute to production of a prompt. A selection management component 130 performs all tasks associated with retrieving function-related information from the data store 120 and providing it to the language model 104. For instance, when requested, the selection management component 130 interacts with the data store 120 to retrieve the selector information 114 and provide it to the language model 104. Further, when requested, the selection management component 130 interacts with the data store 120 to retrieve instances of function definition information for corresponding functions, which the selection management component sends to the language model 104.

In some implementations, the selector information 114 expresses some of the services offered by the selection management function 130 as a function in its own right. The language model 104 invokes this function to access full function definition information for a specified function, providing the function's name or other identifier. In other words, from the perspective of the language model 104, the selection management component 130 is considered a function like any other function offered by the 128.

A context-pruning component 132 removes information from the context information 116 in the data store 118 upon the occurrence of a triggering event, and, in so doing, reduces the size of subsequent prompts that will incorporate the context information 116. For example, the context-pruning component 132 removes an instance of function definition information for a particular function upon a finding that the particular function is no longer needed. The context-pruning component 132 reaches the above conclusion based on the occurrence of one or more triggering events.

Illustrative triggering events that are indicative that the particular function is no longer needed include any one or more of: a) the calling (invocation) of the particular function; and/or b) the failure to call the particular function in a prescribed number of language-model responses; and/or c) the sending of a request to the user to provide additional information; and/or d) the receipt of a new query; e) the determination that the particular function no longer complements a current focus of the user's search, as reflected by a new query; and/or f) a request by the language model 104 for another function, and so on. With respect to event (e), the context-pruning component 132 determines that a new query no longer complements the particular function by performing a lookup operation (which makes reference to pre-generated associations between query keywords and functions), and/or by performing semantic analysis (which compares semantic vectors associated with the new query and the particular function), and so on.

In some examples, the language model 104 discovers that it needs to reference a particular instance of function definition information that it has deleted. The language model 104 addresses this deficiency by again requesting the selection management component 130 to provide the missing instance of function definition information. Section E provides additional information regarding the operation of the context-pruning component 132.

A selector/definition component 134 creates an instance of selector information and/or an instance of function definition information based on reference information provided by one or more sources. For example, the selector/definition component 134 scrapes a particular network-accessible service to discover the functions it uses and the organization of the functions (if any). Alternatively, or in addition, the selection/definition component 134 extracts API-related information published by various sources, such as the GitHub website provided by Microsoft Corporation of Redmond, Washington. The selector/definition creation component 134 then uses the language model 104 (or another language model, not shown) to transform the reference information into one or more instances of selector information and/or one or more instances of function definition information. Section D provides additional information regarding the operation of the selector/definition creation component 134.

Ellipses 136 indicate that the prompt-generating component 110 is capable of incorporating additional functions, not specified in FIG. 1. For example, the prompt-generating component 110 includes a tokenizer for converting any text passage into tokens. The prompt-generating component 110 also includes functionality for adding each query that is received, each language-model response that is generated, and each function-response information that is generated to the context information 116. Further note that not every interaction with the language model 104 necessarily involves interaction with functions. Further, some implementations omit one or more of the components described above.

Finally, note that the data store 120 provides a single instance of selector information 114, and the function definition information 122 provides an unstructured or “flat” collection of instances of function definition information. In other cases, a service organizes its functions in a particular manner. For example, an illustrative system 138 (referred to in FIG. 1 as “system B”) includes three categories (C1, C2, C3) of subtasks. Each category includes a collection of functions that are used in performing a particular subtask. (A category generally describes a group of functions having common characteristics.) For example, the second category C2 includes at least functions F21, F22, and F33. Other systems organize functions using one or more layers of subcategories. The selection/definition creation component 134 creates one or more instances of selector information and/or one or more subsets of instances of function definition information that represent any such organization of functions. A data store 140 stores this function-related information.

For example, the data store 140 stores first-level selector information that allows the language model 104 to choose among the three categories of functions (C1, C2, C3) of the system 138. The data store 140 also stores second-level selector information for each category that allows the language model 104 to choose among the functions associated with that category. In other cases, the data store 140 includes additional layers of selector information. The data store 140 also stores a subset of instances of function definition information associated with each category (or subcategory, if any). Section B provides additional information regarding one manner of interacting with a structured store of function-related information.

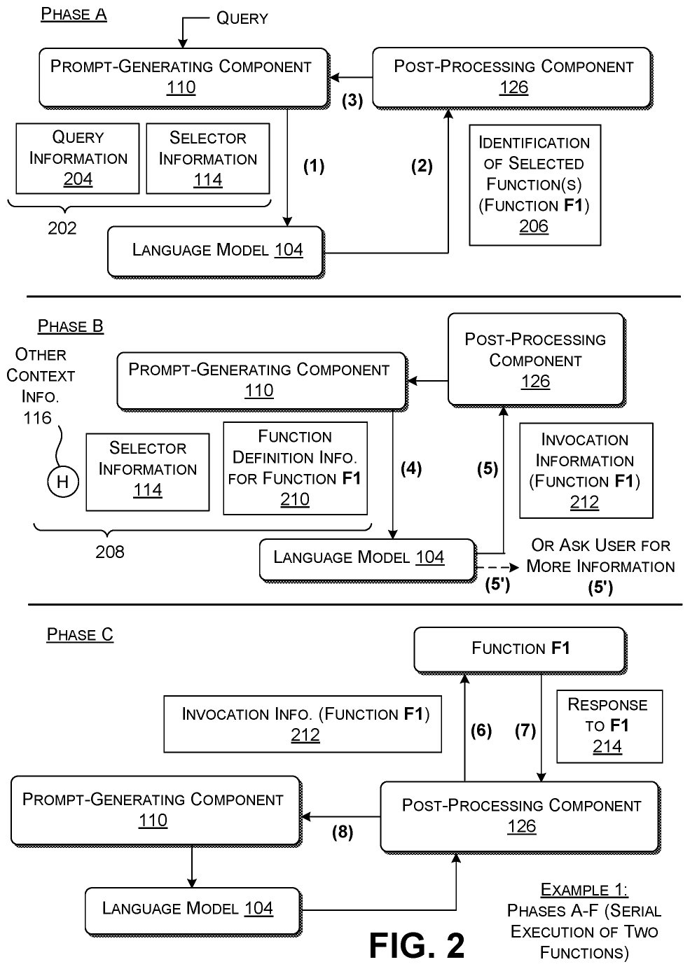

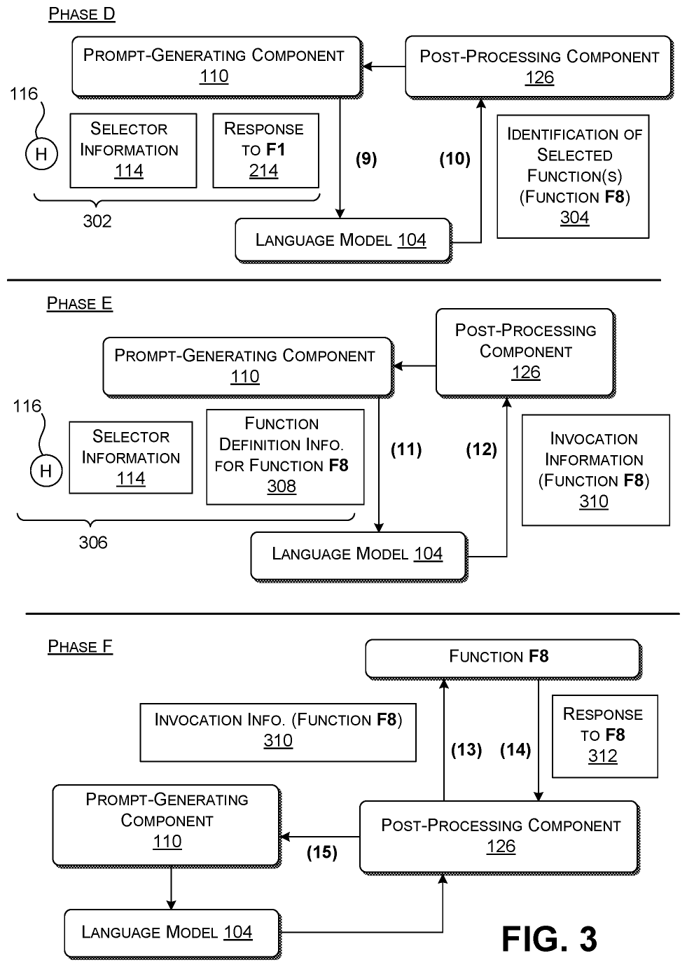

FIGS. 2 and 3 show a first example of the operation of the computing system 102 of FIG. 1. The first example describes six phases A-F performed in series, each phase leveraging results produced in a previous stage. Alternatively, as will be conveyed in the second example shown in Section C, the computing system 102 is capable of creating plural instances of invocation information at the same time, and executing the plural instances in parallel. Further note that other examples deviate from the flow described below by accommodating intermediary interaction with the user and/or other endpoint, and/or by incorporating other intermediary tasks.

In operation (1) of phase A, in response to receiving the query, the prompt-generating component 110 produces a first prompt 202 that includes query information 204 that describes the query and the selector information 114. As previously described, the selector information 114 includes a digest of functions that are capable of being selected by the language model 104. In operation (2), the language model 104 provides identification information 206 that identifies a function F1, e.g., by specifying a name or other identifier associated with this function. The language model 104 generates the identification information 206 in response to the prompt 202. In operation (3), the post-processing component 126 forwards the identification information 206 to the prompt-generating component 110. Generally, the language model 104 is capable of selecting an appropriate function to answer the query based on knowledge encapsulated in its machine-trained parameters. That knowledge ultimately reflects patterns that a training system has detected in processing a large corpus of training examples, each specifying an appropriate function to use when answering a particular query. The language model 104 uses the same knowledge to decide an order in which functions should be invoked, if any. The order of execution is determined, in part, by the input and output characteristics of a group of functions. For a function X that consumes the output of function Y, the language model 104 will determine that function Y should precede the execution of function X.

In operation (4) of phase B, the prompt-generating component 110 generates a second prompt 208 by concatenating context information 116 (e.g., which specifies the tokens in the query information 204), the selector information 114, and function definition information 210 for the function F1. In operation (5), the language model 104 responds to the second prompt 208 by producing invocation information 212, and by forwarding the invocation information 212 to the post-processing component 126. The function definition information 210 provides a more detailed description of the function F1 compared to the digest of this function provided in the selector information 114. The invocation information 212 provides a properly formatted message for invoking the function F1.

In a variation of phase B, the language model 104 discovers that it does not currently possess all of the input arguments specified in the function definition information, which are required by the function F1. In an alternative operation (5′), the language model 104 generates an output message and sends the message to the post-processing component 126 for delivery to the user. The output message asks the user to provide the missing input information. Upon the user's entry of the input information, the computing system 102 repeats phase B. In another variation, the language model 104 invokes any type of supplemental service (such as a machine-trained model that performs image analysis) to provide information that is required to execute the function F1. For the purpose of this example, however, assume that the first case applies, in which the language model 104 sends the invocation information for the function F1 to the post-processing component 126.

In operation (6) of phase C, the post-processing component 126 sends the invocation information 212 to the system 128, which implements function F1. In operation (7), the post-processing component 126 receive function-response information 214, which the function F1 produces in response to the invocation information 212. In operation (8), the post-processing component 126 forwards the function-response information 214 to the prompt-generating component 110.

Advancing to FIG. 3, in operation (9) of phase D, the prompt-generating component 110 produces a third prompt 302 that contains the selector information 114 and the function-response information 214 produced by the function F1 in phase C). In operation (10), the prompt-generating component 110 produces identification information 304 which identifies function F8, based on a selection made by the language model 104 in response to the third prompt 302.

In operation (11) of phase E, the prompt-generating component 110 produces a fourth prompt 306 that includes the selector information 114 and function definition information 308 that describes the function F8. In operation (12), the post-post-processing component 126 receives invocation information 310 from the language model 104, which the language model 104 generates in response to the fourth prompt 306. The language model 104 is capable of producing correct invocation information for a particular function based on the knowledge embodied in its machine-trained weights.

In operation (13) of phase F, the post-processing component 126 sends the invocation information 310 to the system 128 which implements the function F8. In operation (14), the post-processing component 126 receives function-response information 312 from the function F8, which the function F8 produces in response to executing the function F8. In operation (15), the post-processing component 126 forwards the function-response information 312 to the prompt-generating component 110 to commence another cycle of phases D through F.

Alternatively, the post-processing component 126 generates final output information based on any instances of function-response information received so far and/or other information produced by the language model 104. Alternatively, the prompt-generating component 110 produces a prompt that contains all instances of function-response information and all instances of language-model responses produced thus far, with an instruction to compile this information into final output information in a particular way, as guided by the query. The language model 104 performs this task based on the prompt and sends a language-model response to the post-processing component 126 that represents the outcome of its processing. The post-processing component 126 sends the final output information to the user via the local computing device 106.

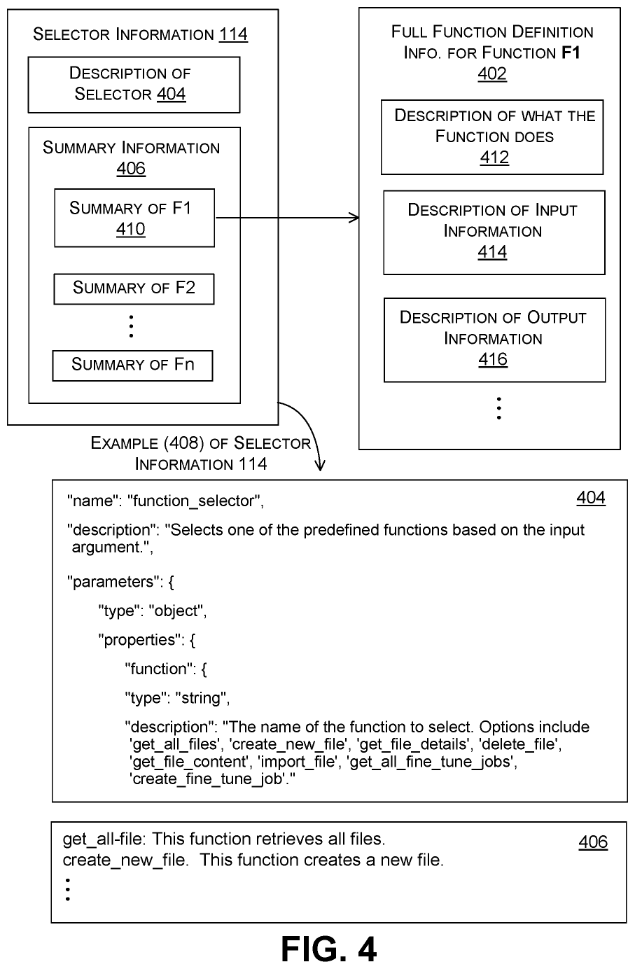

FIG. 4 shows one implementation of the selector information 114 and function definition information 402 for a particular function (F1), which is one function among a group of available functions. FIG. 4 specifically represents the case described in FIG. 1, in which the data store 120 stores a single instance of selector information 114 for use in accessed an unstructured collection of functions.

The selector information 114 includes a description 404 that sets forth the selection task that is being requested of the language model 104. For example, the description 404 describes the task as follows: “Your task is to select one or of the functions summarized below that will assist you in answering the query.” In some implementations, the description 404 also requests the language model 104 to execute two or more functions in parallel upon the occurrence of a triggering condition. In some implementations, the triggering condition is the presence of an explicit flag added to the query (e.g., by the user) that specifies that the functions are to be executed in parallel. Alternatively, or in addition, the triggering condition is a determination made by the language model 104 itself that the functions are capable of being executed in parallel. For example, the description 404 informs the language model 104 that it is appropriate to execute plural functions in parallel if none of the functions require input information that is supplied by any other function. In some implementations, the description 404 also specifies the format at which the language model 104 is to specify the function(s) it has selected. Although not shown, the description 404 is also capable of providing examples of queries that can be processed in parallel, and optionally queries that cannot be processed in parallel. Section C provides additional information regarding the use of the computing system 102 to perform parallel processing.

The selector information 114 also includes summary information 406. The summary information 406 provides a brief (e.g., one-phrase, one-sentence, or few-sentence) description of each function that is capable of being invoked. The summary information 406 also provides an identifier by which each function is capable of being referenced.

FIG. 4 also provides a representative example 408 of the selector information 114. Here, the description 404 is structured as a function definition that provides a description of the operations performed by the function, which is expressed as: “Selects one of the predefined functions based on the input argument.” The description 404 defines the parameters used by the function, e.g., by describing the type of each parameter and the permissible values that each value is able to assume. The summary information 406 provides a name and one-sentence description of each of the functions that are capable of being selected. In this example, the functions perform different file management operations.

The particular function definition information 402 describes the function F1 with more detail (and hence more tokens) compared to a counterpart digest 410 provided in the summary information 406. In some implementations, the function definition information 402 includes any of: a) a more detailed description 412 of operations performed by the function F1 (compared the digest 410); b) a description 414 of arguments that the function F1 receives as input; c) a description 416 of the format of output information produced by the function F1; and/or d) a description of a schema (not shown) used by the function F1. Overall, the function definition information 402 provides sufficient information to enable the language model 104 to produce properly formatted invocation information (e.g., an API message) to the system 128, which enables the system 128 to execute the function F1. Although not shown, in some examples, the function definition information 402 also includes one or more examples of properly formatted invocation information.

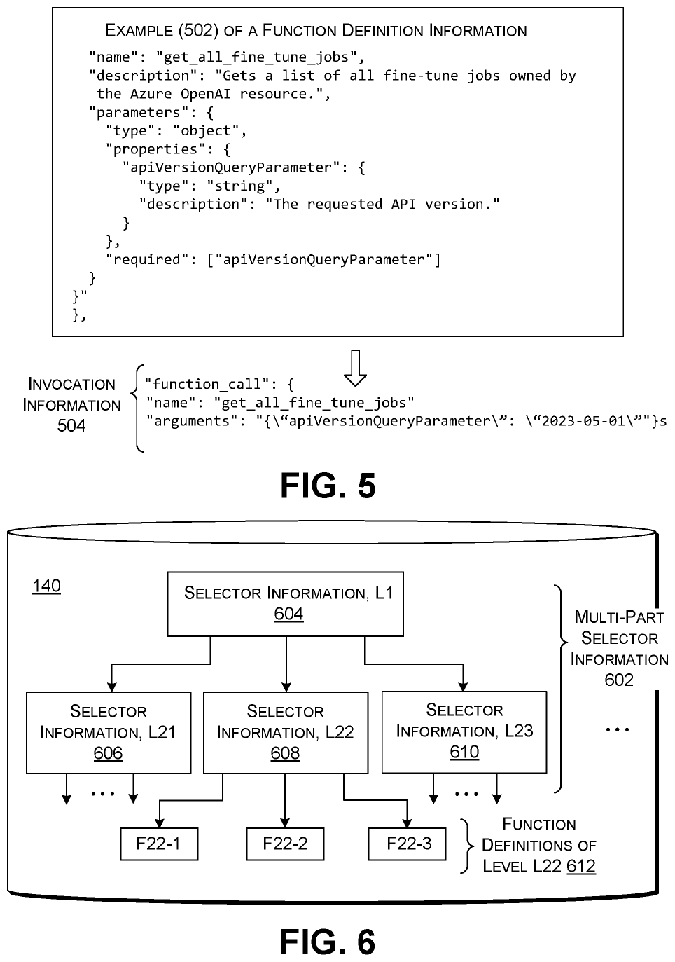

FIG. 5 shows an example of function definition information 502 for a particular function. In this case, the function obtains a list of jobs that meet specified characteristics. The function definition information 502 specifies the input arguments to be input to this function. The prompt-generating component 110 represents the function definition information 502 using a set of tokens. By selectively only forwarding the tokens for this particular function (and not, for example, all of the functions identified in the data store 120), the prompt-generating component 110 is able to reduce the size of the prompt by orders of magnitude.

FIG. 5 also shows an example of invocation information 504 produced by the language model 104 in response to the function definition information 502. The invocation information 504 calls the function by name, and includes the input parameters specified by the function definition information 502.

### B. Interacting With Multi-Level Selector Information

FIG. 6 shows an example in which the data store 140 stores function-related information in a hierarchical data structure. The data structure includes multi-part selector information 602, and a subset of instances of function definition information associated with each terminal category node of the data structure. For instance, assume that a source (or plural sources) of functions organize their functions in different categories. An instance of first-level selector information 604 enables the language model 104 to choose among the different categories, based on the query that has been input. Plural instances of second-level selector information (606, 608, 610) allow the language model 104 to choose among subsets of functions associated with each category. For instance, the instance of second-level selector information 608 allows the language model 104 to choose among instances 612 of function definition information for functions F22-1, F22-2, and F22-3. In summary, each instance of selector information configures the language model 104 and the selection management component 130 to perform a multiplexing action, either choosing a subcategory or an instance of function definition information.

In some examples, the computing system 102 interacts with the data structure shown in FIG. 6 in the following manner. In a first operation, the prompt-generating component 110 sends a first prompt to the language model 104 that contains the query information and the instance of the first-level selector information 604. In a second operation, the prompt-generating component 110 receives, via the post-processing component 126, the language model's selection of one of the categories described in the instance of first-level multi-part selector information 604. In a third operation, the prompt-generating component 110 generates a second prompt that includes the instance of second-level selector information for the selected category. In a fourth operation, the prompt-generating component 110 receives, via the post-processing component 126, the language model's selection of one of the functions associated with the selected category. In a fifth operation, the prompt-generating component 110 sends a third prompt that includes the function definition information for the selected function. In a sixth operation, the post-processing component 126 receives invocation information produced by the language model 104 based on the provided function definition information. Different implementations apply different rules to govern whether or not previously-transmitted instances of selector information are re-sent to the language model 104 with each prompt.

To be more specific, assume that the data structure in the data store 140 represents the organization of product categories provided by a network-accessible retail service. Each category hosts a set of functions that are used to interact with products of a particular kind (e.g., electronic products, books, clothing, and kitchen appliances, and furniture). A transaction is performed with this retail service by first selecting a product category, and then selecting a desired function within that product category. The computing system 102 uses the selected function to interact with the appropriate product category of the retail service.

In another example, assume that the data structure in the data store 140 represents the organization of file processing categories provided by a file management service. Each category hosts a set of functions that are used to perform operations within a general subtask associated with file management. One such subtask, for example, is the encryption of data. A transaction is performed with this file management service by first selecting a subtask category, and then selecting a desired function within that subtask category. The computing system 102 uses the selected function to perform an operation associated with the selected subtask.

The prompt-generating component 110 is able to reduce the size of its prompts using the above-described hierarchical data structure. This is because, at any given stage, the prompt-generating component 110 need only reference a targeted subset of function-related information. A prompt that simultaneously specifies all the functions encompassed by a multi-category service would require a large number of tokens. As previously explained, large prompts are costly, resource-intensive, and degrade the quality of output results produced by the language model 104 (e.g., because the most relevant tokens in a large set of tokens are at risk of being “lost in context”).

### C. Invoking Calls to Functions in Parallel

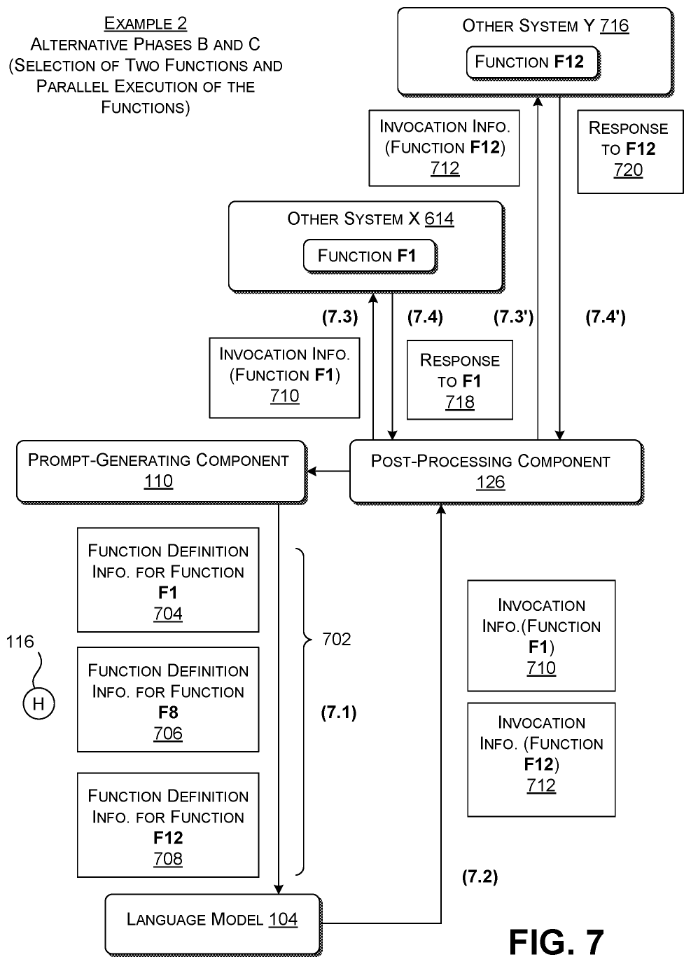

FIG. 7 shows a second example of the operation of the computing system 102 of FIG. 2. Assume in this case that, in a prior pass (not shown), the language model has produced identification information that identifies functions F1, F8, and F12. In operation (7.1), the prompt-generating component 110 produces a prompt 702 that includes instances of function definition information (704, 707, 708) for functions F1, F8, and F12. In operation (7.2), assume that the language model 104 chooses to invoke functions F1 and F12, but not function F8. In response, the language model 104 provides a first instance of invocation information 710 for function F1 and a second instance of invocation information 712 for function F12.

The language model 104 is guided by the following input items when making a decision with respect to parallelization: the input query, the context information, and the statistical patterns embodied in its machine-trained parameters. The language model 104 is also instructed via a system prompt to: a) identify, whenever possible, plural functions that are capable of being called in parallel (because they are mutually independent); (b) to request plural instances of associated function definition information at the same time; and (c) to generate plural instances of associated invocation at the same time.

In operations (7.3) and (7.3′), the post-processing component 126 sends the two instances of invocation information (710, 712) to two different systems (714, 716), respectively. For example, the system 714 is a network-accessible service for implementing function F1, and the system 716 is a network-accessible service for implementing function F12. Alternatively, a single system implements these two functions. In operations (7.4) and (7.4′), the post-processing component 126 receives instances of function-response information (718, 720) from the systems (714, 716). These two separate interactions with the systems (714, 716) occur in parallel (although one function may take longer to perform than the other, causing one instance of function-response information to be received after the other).

Consider the following examples of the type of parallel processing set forth in FIG. 7. In a first scenario, the computing system 102 generates product suggestions when a user is viewing a particular product page, using two or more different kinds of retrieval techniques. For example, a first retrieval technique searches the user's browsing history and then selects one or more products that complement the particular product that the user is currently viewing, with emphasis on products for which the user has shown a prior interest. A second retrieval technique uses a machine-trained neural network to perform image recognition on a product image on the product page that the user is currently viewing, and selects one or more products that are assessed as visually similar to the particular product that the user is viewing (e.g., where similarity is assessed using any distance measure, such as cosine similarity between vectors that represents a pair of images). A third retrieval technique performs sentiment analysis on product reviews associated with the product that the user is currently viewing (e.g., using a machine-trained model, such as a BERT-based transformer model, and/or a rules-based system), and then selects one or more products that are identified in the product reviews and are assessed as favorably regarded in the product reviews.

The language model 104 determines that these three techniques are mutually independent based on an explicit flag added to the query, and/or based on the language model's independent assessment. For example, the language model 104 determines that none of these techniques requires input information that depends on the execution of any other technique, and no overarching process requires the output results of one technique before the other. The language model 104 generates plural instances of invocation information for these three techniques. The post-processing component 126 simultaneously invokes all three techniques, and receives product recommendations for all three techniques (although not necessarily at the same time). The post-processing component 126 applies one or more rules to merge the results of the three techniques in any manner, e.g., by concatenating the subsets of product recommendations together and removing duplicate recommendations. Alternatively, or in addition, the post-processing component 126 relies on the prompt-generating component 110 to instruct the language model 104 to consolidate the plural subsets of recommendations into a final set of recommendations, e.g., by ranking the recommendations in the plural subsets.

Another example performs a search for a product specified by a query over plural platforms that use different respective sets of functions. In this case, the computing system 102 relies on the prompt-generating component 110, the language model 104, and the post-processing component 126 to invoke searches over the different platforms at the same time. The post-processing component 126, with the optional assistance of the language model 104, consolidates the search results provided by the plural searches. In more complex variants of this process, the computing system 102 relies on the language model 104 to perform synthesis of the results to provide an answer to a specific query, such as “What is the best price of camera model NK123,” and/or “Is it a good time to purchase camera model NK123 based on the current price and a history of previous prices?” To perform this more complex synthesis, the concurrent search executed on plural platforms collects current price information and prior price information for this model of camera.

Another example applies the MapReduce technique using the processing flow shown in FIG. 7. That is, the computing system 102 relies on the prompt-generating component 110, the language model 104, and the post-processing component 126 to cooperatively perform the mapping part of the MapReduce technique in a parallel fashion. This provides plural subsets of results for plural instances of input information. The post-processing component 126, with the optional assistance of the language model 104, performs the reducing part of the MapReduce technique by merging the plural subsets of data results together into a final set of results.

Another application of the type of processing shown in FIG. 7 uses parallel function calls to collect independent pieces of evidence that are used to make a final determination. For example, assume that a user asks, “Does this image show a type of berry that is edible?” A first technique searches text-based reference sources (such as Wikipedia) for general information about edible and non-edible berries. A second technique, performed in parallel with first technique, performs image analysis on a user's input image (e.g., using a machine-trained neural network). The computing system 102 uses the language model 104 to make a determination of whether the berry shown the image can be eaten, based on both pieces of evidence collected by the two techniques.

In general, the type of processing shown in FIG. 7 is advantageous because it reduces the amount of time required to provide final output results to the user. This is because the computing system 102 performs at least part of its processing in a concurrent fashion, rather the serially. The processing shown in FIG. 7 also reduces the number of transitions between the use of graphics processing units (GPUs) (e.g., which are used to perform language-model processing operations) and the use of main processors (e.g., which are used to interact with the APIs). These types of transitions require time and resources to perform. Hence, by reducing these transitions, the computing system 102 reduces overall latency and the amount of resources consumed (including memory and processor resources) by the computing system 102.

In some implementations, the prompt-generating component performs the additional operation of partitioning a single prompt into plural component prompts. The prompt-generating component 110 partitions the single prompt in this manner upon a finding that a prescribed triggering condition has been reached. For example, the prompt-generating component 110 performs this partition upon a finding that the original query specifies independent tasks (in which the execution of each task does not depend on the execution of other tasks), and in which each task involves interacting with a subset of candidate functions. In other implementations, the prompt-generating component 110 consults the language model 104 to make a determination of whether the single prompt is capable of being partitioned and processed in parallel. In some implementations, each component query includes a common part and an instance-specific part. The instance-specific part describes a subtask of a main task specified by the query.

In some implementations, the language model 104 uses plural processor instances, each of which execute an instance of the language-model's processing flow, e.g., using a separate processing thread. The processing instances produce respective component responses. The post-processing component 126 acts on the component responses in the manner previously described. Further information regarding the parallel execution of component prompts is set forth in co-pending and commonly-assigned U.S. patent application Ser. No. 18/385,408 to Sayan, et al. (the '408 Application), and entitled “Reducing Latency by Processing Parts of a Language Model Query in Parallel,” and filed on Oct. 31, 2023. The '408 Application is incorporated herein by reference in its entirety.

### D. Operation of the Selector/Definition Creation Component

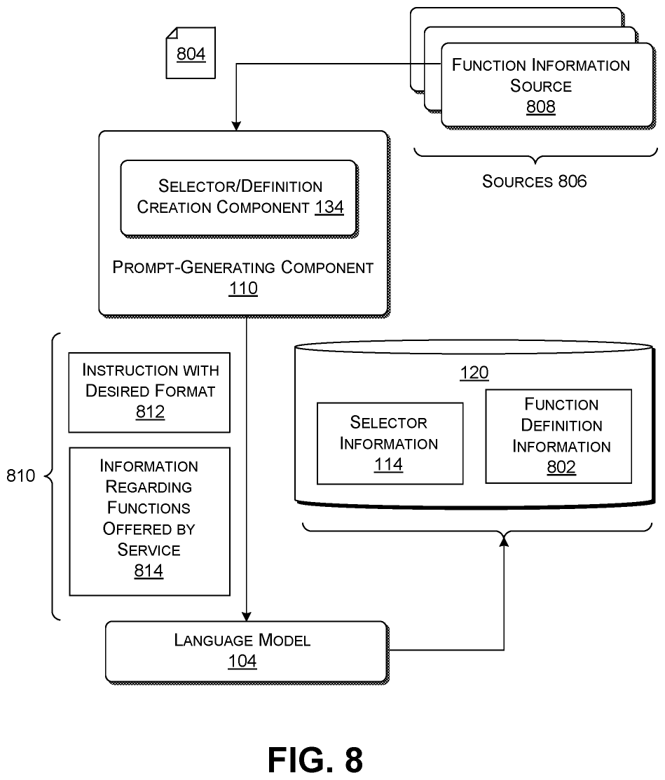

FIG. 8 shows one approach for producing the selector information 114 of FIG. 1 and the instances of function definition information 802 associated with selector information 114. The approach is also capable of producing the instance of multi-part selector information 602 of FIG. 6 and the sets of instances of function definition information associated with each category in the multi-part selector information 602; however, to facilitate explanation, FIG. 8 is first explained below in the context of the example of FIG. 1, which uses a single instance of selector information 114.

The prompt-generating component 110 receives reference information 804 from one or more reference information sources 806, including representative reference information source 808. For example, assume that the reference information source 808 is a network-accessible service that performs prescribed operations, optionally grouped into plural categories of sub-functions. A scraping component (not shown) produces the reference information 804 by extracting information regarding the internal structure of the network-accessible service and/or any additional documentation published by the network-accessible service. This reveals the functions used by the network-accessible service, and their organization within the service. Another reference source is a general repository of API information published by any source, such as the GitHub website. An access component (not shown) retrieves reference information from that repository by performing a search for the kind of functions that are anticipated to be of use by the language model 104 in responding to user queries.

The prompt-generating component 110 uses the selector/definition component 134 to generate a prompt 810 that provides an instruction 812 and function-related information 814. The instruction 812 directs the language model 104 to generate the selector information 114 and the function definition information 802 based on the prompt 810. The instruction 812 optionally specifies the desired schema that the selector information 114 is to use, and the desired schema of each instance of function definition information. The selector/definition creation component 134 generates the function-related information 814 by tokenizing one or more instances of reference information collected from the above-described reference information sources 806. The language model 104 then carries out the instruction 812 to transform the function-related information 814 into the selector information 114 and the function definition information 802.

Alternatively, the language model 104 concludes that it does not have sufficient information to produce the selector information 114 and/or the instances of function definition information 802. In response, the language model 104 generates a language-model response that requests a user or automated system to collect and supply additional reference information.

The language model 104 is also capable of creating a multi-part selector that represents a structured organization of functions described in the reference information. In other cases, the reference information does not explicitly identify different categories of functions. In some implementations, the selector/definition creation component 134 addresses this finding by instructing the language model 104 to forms groups of functions that perform related functions, and to establish a category associated with each group. In other words, the select/definition creation component 134 requests the language model 134 to perform cluster analysis based on the reference information that has been collected. In some implementations, two functions are assessed as related if the cosine distance between their vector representations is below a prescribed threshold value, and/or based on their lexical similarity (as determined by any of keyword matching, edit distance analysis, etc.).

In some implementations, the computing system 102 performs the above-described operations as a background task, in advance of processing queries. In other implementations, the computing system 102 invokes the selector/definition creation component 134 as a preliminary task in the processing of a particular individual query. In some implementations, the computing system 102 makes this decision upon determining that the input query requires one or more functions that are not currently represented in the data stores (120, 160).

In some implementations, in performing the functions of FIG. 8, the computing system 102 repurposes the same prompt-generating component 110 and the language model 104 that is used to process queries in the manner described in Section A. In other implementations, the computing system 102 relies on a different prompt-generating component and/or a different language model to perform the task of FIG. 8, compared to that used to perform the operations described in Section A. For instance, the other language model is fine-tuned to perform the task of generating the selector information 114 (or the multi-part selector information 602) and the function definition information 802.

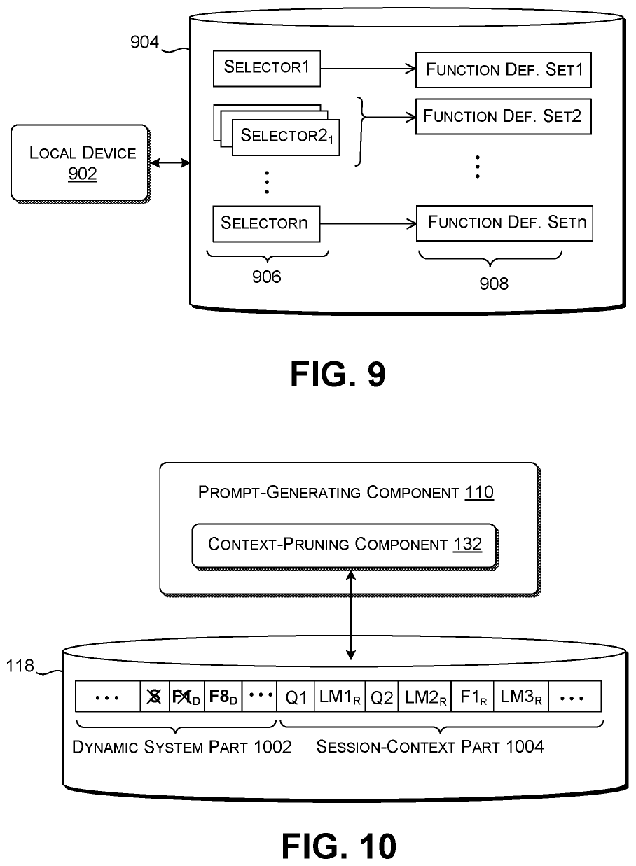

FIG. 9 shows an implementation in which a local device 902 interacts with a repository in a data store 904 that provides pre-generated instances 906 of different selector information and pre-generated sets of instances of function definition information 908. In some examples, each set of instances of function definition information is associated with one or more particular instances of selector information, as represented by the links shown in FIG. 9. In some examples, some instances of selector information are single-part instances of selector information, and other instances of selector information are multi-part instances of selector information. In some implementations, the data store 904 is a local resource, e.g., implemented by the local computing device 902. Alternatively, or in addition, the data store 904 is provided by a network-accessible system; here, the local computing device 902 interacts with the network-accessible system using a browser application or other interface mechanism.

An individual with proper authority (e.g., a developer, administrator, or end user) makes selections within the repository to create a custom library of instances of function definition information, and a particular instance of selector information that complements the selected instances of function definition information. For example, a developer of a shopping website chooses instances of function definition information and a complementary instance of selector information that are most optimally suited for the kind of operations performed by shopping websites. A developer of an image-processing application chooses function definition information and a complementary instance of selector information that are most optimally suited for the kind of operations performs by image-processing applications, and so on. The data store 120 or the data store 140 of the computing system 102 stores the selected instances of function definition information and the selected instance of selector information 114, for subsequent use in processing individual queries.

### E. Operation of the Context-Pruning Component

FIG. 10 shows one manner of operation of the context-pruning component 132. As explained in Section A, the context-pruning component 132 removes function-related information from the context information 116 in the context store 118 in response to the occurrence of one or more triggering events, examples of which were provided in Section A. To review, one event is the calling of a function for which a counterpart instance of function definition information has been stored. Another event is a determination that a particular function serves a purpose that is no longer useful in addressing a current focus of the user's query. Another event is a determination that a particular function for which function definition information has been stored has not been invoked in a prescribed number of language-model responses, or, more generally, within a window defined in a manner that expresses an amount of processing that has been performed by the computing system 102 (time, tokens consumed, etc.).

In some implementations, each prompt includes a system part 1002 and a session-context part 1004. The system part 1002 includes general instructions to the language model 104, such as the instruction: “You are a friendly assistant that helps users find information.” The system part 1002 also includes more general instructions that direct the language model 104 to interpret instances of selector information and instances of function definition information in a particular manner. The system part 1002 also includes particular instances of selector information and particular instances of function definition information that it has received in one or more passes. FIG. 10 specifically indicates that the system part 1002 once included an instance of selector information (S) and an instance function definition information (F1_{D}) for function F1, but that these two items were subsequently removed by the context-pruning component 132. FIG. 10 shows that the system part 1002 currently stores function definition information (F8_{D}) for function F8.

The session-context part 1004 adds information to the end of its stack upon production of this information. FIG. 10 specifically shows an example in which the session-context part 1004 stores query information (Q) pertaining to individual queries that have been received from the local computing device 106, language model responses (LM_{R}) that have been received from the language model 104, and instances of function-response information (F_{R}) that have been received from the invoked functions. The prompt-generating component 110 will flush all or some of context information in the data store 118 upon the occurrence of different termination events, e.g., upon a signal that the user has finished a first search and is now commencing an independent second search, or upon a signal that the user is terminating a chat session and closing a chat application. The shift in focus from a first search to a second search is detectable based on explicit control information added to the queries, and/or based on semantic and/or lexical analysis of the queries.

In some implementations, the context-pruning component 132 dynamically updates the function-related information in the system part 1002 based on the current needs of a session. The context-pruning component 132 leaves the session-context part 1004 intact. In other examples, however, the context-pruning component 132 also actively manages some content in the session-context part 1104. For example, the context-pruning component 132 removes an instance of function-response information based on an assessment that the function-response information does not semantically match a current focus of the user's current search objectives.

The context-pruning component 132 ultimately serves the purpose of reducing the size of prompts sent to the language model 104. In so doing, the context-pruning component 132 enables the computing system 102 to reduce the use of memory and processor resources. The context-pruning component 132 also reduces the risk that a particular query will exceed the maximum token limits associated with the particular language model being used.

### F. Representative Language Model

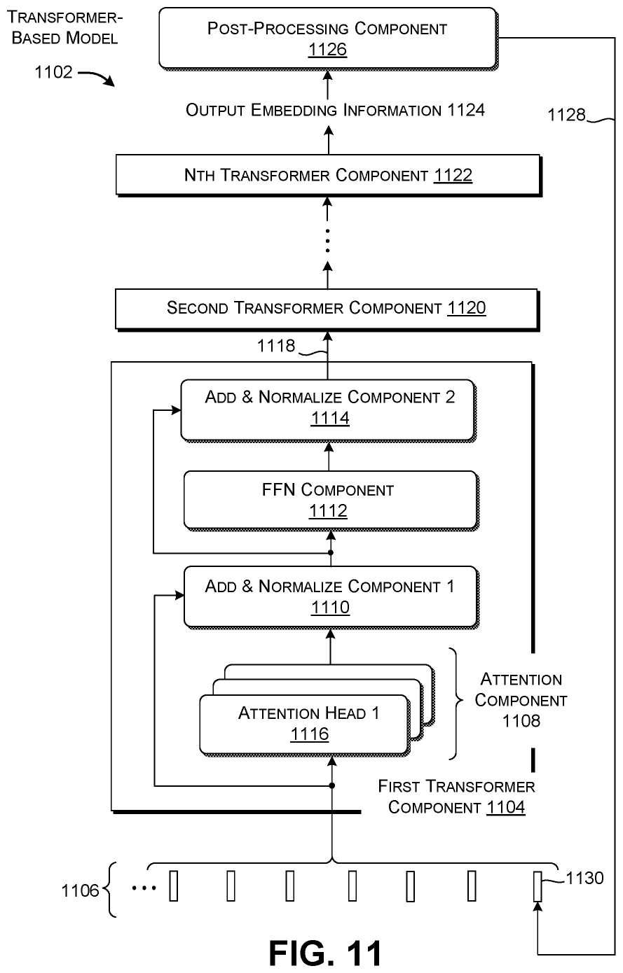

FIG. 11 shows a transformer-based language model (“language model”) 1102 for implementing the language model 104 referenced by FIG. 1. The language model 1102 is composed, in part, of a pipeline of transformer components, including a first transformer component 1104. FIG. 11 provides details regarding one way to implement the first transformer component 1104. Although not specifically illustrated, other transformer components of the language model 1102 have the same architecture and perform the same functions as the first transformer component 1104 (but are governed by separate sets of weights).

The language model 1102 commences its operation with the receipt of input information, such as a passage of text. The prompt includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information; in other examples, the language model 1102 operates on any of: audio information, image information, video information, sensor information, and so on, or any combination thereof. In some implementations, the tokens associated with an image are respective n×m pixel portions of the image.

Next, an embedding component (not shown) maps the sequence of tokens into respective token embeddings. For example, with respect to text-based tokens, the embedding component produces one-hot vectors that describe the tokens, and then maps the one-hot vectors into the token embeddings using a machine-trained linear transformation. The embedding component converts image-based tokens into token embeddings using any type of neural network, such as a convolutional neural network (CNN). The embedding component then adds position information (and, in some cases, segment information) to the respective token embeddings to produce position-supplemented embedding vectors 1106. The position information added to each token embedding describes the embedding vector's position in the sequence of token embeddings.

The first transformer component 1104 operates on the position-supplemented embedding vectors 1106. In some implementations, the first transformer component 1104 includes, in order, an attention component 1108, a first add-and-normalize component 1110, a feed-forward neural network (FFN) component 1112, and a second add-and-normalize component 1114.

The attention component 1108 determines how much emphasis should be placed on parts of input information when interpreting other parts of the input information. Consider, for example, a sentence that reads: “I asked the professor a question, but he could not answer it.” When interpreting the word “it,” the attention component 1108 will determine how much weight or emphasis should be placed on each of the words of the sentence. The attention component 1108 will find that the word “question” is most significant.

The attention component 1108 performs attention analysis using the following equation:

$$Attention ( Q , K , V ) = softmax ( \frac{Q {K}^{T}}{\sqrt{{d}_{k}}} ) V . \qquad ( 1 )$$

The attention component 1108 produces query information Q by multiplying the position-supplemented embedding vectors 1106 by a query weighting matrix W^{Q}. Similarly, the attention component 1108 produces key information K and value information V by multiplying the position-supplemented embedding vectors 1106 by a key weighting matrix W^{K} and a value weighting matrix W^{V}, respectively. To execute Equation (1), the attention component 1108 takes the dot product of Q with the transpose of K, and then divides the dot product by a scaling factor \sqrt{d}, to produce a scaled result. The symbol d represents the dimensionality of Q and K. The attention component 1108 takes the Softmax (normalized exponential function) of the scaled result, and then multiplies the result of the Softmax operation by V, to produce attention output information. More generally stated, the attention component 1108 determines how much emphasis should be placed on each part of input embedding information when interpreting other parts of the input embedding information, and when interpreting the same part. In some cases, the attention component 1108 is said to perform masked attention insofar as the attention component 1108 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 11 shows that the attention component 1108 is composed of plural attention heads, including a representative attention head 1116. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1108 concatenates the output results of the attention component's separate attention heads, and then multiplies the results of this concatenation by another weight matrix W^{O}.

The add-and-normalize component 1110 includes a residual connection that combines (e.g., sums) input information fed to the attention component 1108 with the output information generated by the attention component 1108. The add-and-normalize component 1110 then normalizes the output information generated by the residual connection, e.g., by layer-normalizing values in the output information based on the mean and standard deviation of those values, or by performing root-mean-squared normalization. The other add-and-normalize component 1114 performs the same functions as the first-mentioned add-and-normalize component 1110. The FFN component 1112 transforms input information to output information using a feed-forward neural network having any number of layers.

The first transformer component 1104 produces output embedding information 1118. A series of other transformer components (1120, . . . , 1122) perform the same functions as the first transformer component 1104, each operating on output embedding information produced by its immediately preceding transformer component. Each transformer component uses its own level-specific set of machine-trained weights. The final transformer component 1122 in the language model 1102 produces final output embedding information 1124.

In some implementations, a post-processing component 1126 performs post-processing operations on the final output embedding information 1124. For example, the post-processing component 1126 performs a machine-trained linear transformation on the final output embedding information 1124, and processes the results of this transformation using a Softmax component (not shown). The language model 1102 uses the output of the post-processing component 1126 to predict the next token in the input sequence of tokens. In some applications, the language model 1102 performs this task using a greedy selection approach (e.g., by selecting the token having the highest probability), or by using the beam search algorithm (e.g., by traversing a tree that expresses a search space of candidate next tokens).

In some implementations, the language model 1102 operates in an auto-regressive manner, as indicated by the loop 1128. To operate in this way, the language model 1102 appends a predicted token to the end of the sequence of input tokens, to provide an updated sequence of tokens. The predicted token leads to the production of a new position-supplemented vector 1130. In a next pass, the language model 1102 processes the updated sequence of position-supplemented vectors to generate a next predicted token. The language model 1102 repeats the above process until it generates a specified stop token.

The above-described implementation of the language model 1102 relies on a decoder-only architecture. Other implementations of the language model 1102 use an encoder-decoder transformer-based architecture. Here, a transformer-based decoder receives encoder output information produced by a transformer-based encoder, together with decoder input information. The encoder output information specifically includes key-value (KV) information that serves as input to the attention components of the decoder (except the first transformer component).

In some implementations, the language model 1102 is a general-purpose, publicly-available, pre-trained language model. One such model is described in Touvron, et al., “LLaMA: Open and Efficient Foundation Language Models,” arXiv, arXiv: 2302.13971v1 [cs.CL], Feb. 27, 2023, 27 pages. Another example of a publicly-available pre-trained model language model is the BLOOM model described in Scao, et al., “BLOOM: A 176B-Parameter Open-Access Multilingual Language Model,” arXiv, arXiv: 2211.05100v2 [cs.CL], Dec. 11, 2022, 62 pages. Background on the general task of pre-training generative language models is provided in Radford, et al., “Improving Language Understanding by Generative Pre-training,” OpenAI, San Francisco California, Jun. 11, 2018, 12 pages. One publicly-available model that is specifically trained to operate in function-calling application is the GPT-4 model available from OpenAI.

In other examples, a training system (not shown) further fine-tunes the pre-trained language model to function in the manner described in Section A. The training system performs fine-tuning based on a corpus of training examples. Each positive training example in the corpus specifies a prompt and a ground-truth response to the prompt that is considered correct. In some training examples, for instance, the response provides identification information that correctly selects an appropriate function. In other training examples, the response provides invocation information that is considered operable to invoke the correct intended function. The training system iteratively updates weights of the language model to minimize differences between model-generated responses and ground-truth responses (which are given by the training corpus). The differences are expressible, for instance, using a cross entropy loss function. The training system updates the weights using stochastic gradient descent in combination with back propagation. In other examples, as mentioned above, a general-purpose language model is used without pre-training it.

Other implementations of the language model 1102 use other kinds of machine-trained models besides, or in addition to, the particular transformer-based architecture shown in FIG. 11. The other machine-trained models include any of CNNs, recursive neural networks (RNNs), fully-connected feed-forward neural networks (FFNS), stable diffusion models, etc., or any combination thereof.

### G. Illustrative Processes

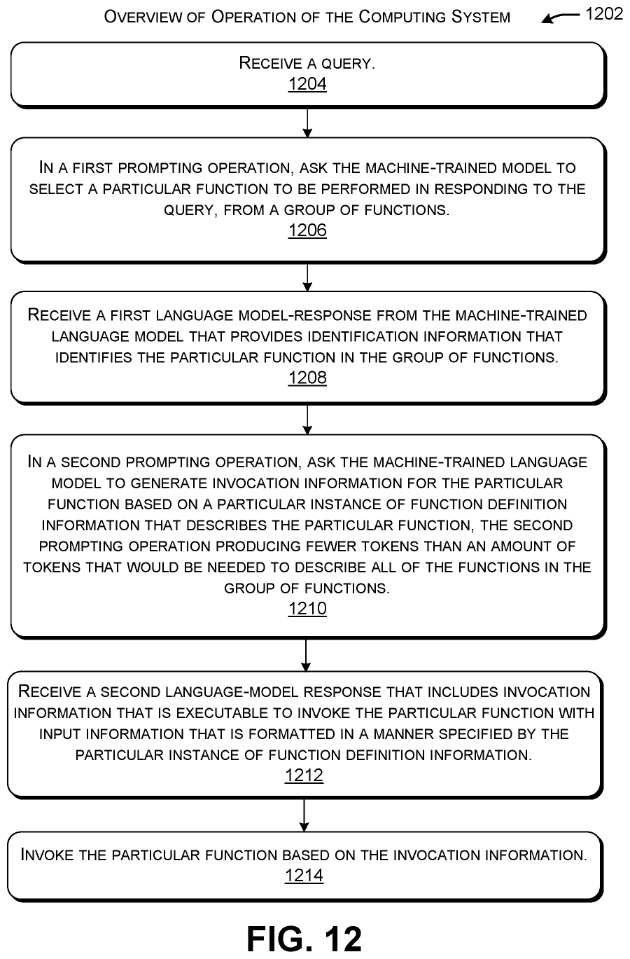

FIGS. 12-14 show two processes that represent an overview of the operation of the computing system of FIG. 1. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 15 and 16.

More specifically, FIG. 12 shows a process 1202 that provides an overview of one manner for processing a query using a machine-trained language model (e.g., the language model 104). In block 1204, the computing system 102 receives the query. In block 1206, in a first prompting operation, the computing system 102 asks the machine-trained model to select a particular function to be performed in responding to the query, from a group of functions. In block 1208, the computing system 102 receives a first language-model response from the machine-trained language model that provides identification information that identifies the particular function in the group of functions. In block 1210, in a second prompting operation, the computing system 102 asks the machine-trained language model to generate invocation information for the particular function based on a particular instance of function definition information that describes the particular function, the second prompting operation producing fewer tokens than an amount of tokens that would be needed to describe all of the functions in the group of functions. In block 1212, the computing system 102 receives a second language-model response that includes invocation information that is executable to invoke the particular function. In block 1214, the computing system 102 invokes the particular function specified by the invocation information.

One particular instantiation of the process 1202 is described as follows. In block 1204, the computing system 102 receives a query. In block 1206, in a first prompting operation, the computing system 102 asks the machine-trained model to select a particular application programming interface (API) to be called in responding to the query, from a group of APIs. In block 1208, the computing system 102 receives a first language-model response from the machine-trained language model that provides identification information that identifies the particular API in the group of APIs that is selected. In block 1210, in a second prompting operation, the computing system 102 asks the machine-trained language model to generate an API message to be input to the particular API that conforms to a particular instance of function definition information that describes the particular API, the second prompting operation producing fewer tokens than an of amount of tokens that would be needed to describe all of the APIs in the group of APIs. In block 1212, the computing system 102 receives a second language-model response that includes the API message that is generated, to be input to the particular API. In block 1214, the computing system 102 sends the API message to the particular API to invoke the particular API.

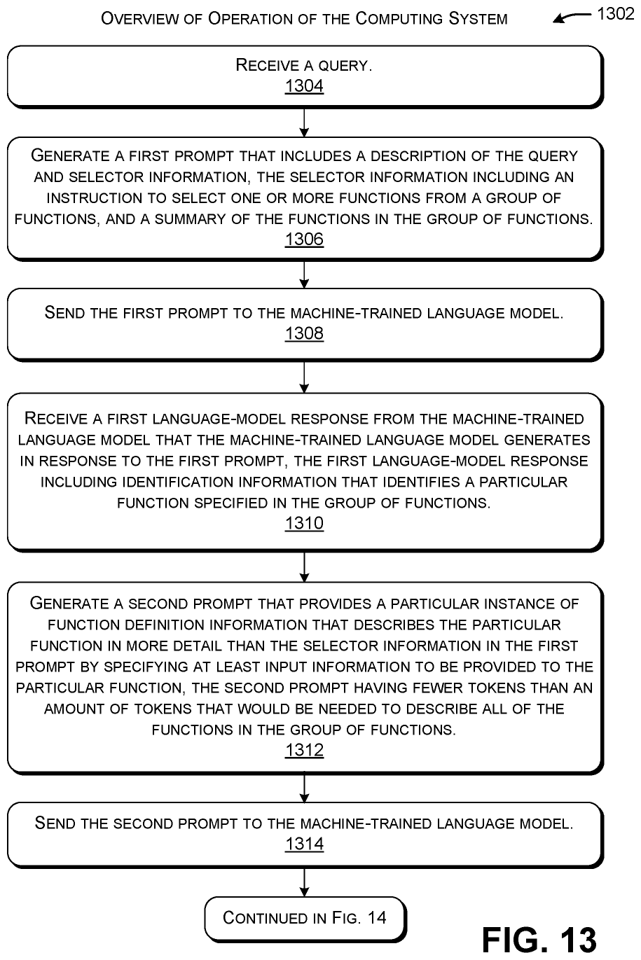

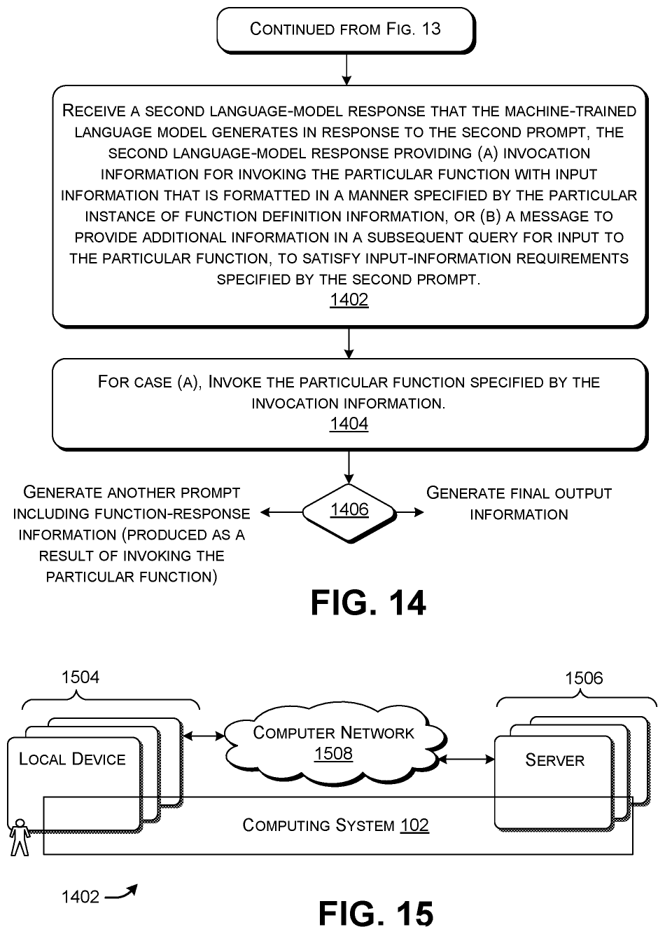

FIGS. 13 and 14 together shows a process 1302 that provides another overview of one manner for processing a query using a machine-trained language model (e.g., the language model 104). In block 1304, the computing system 102 receives the query. In block 1306, the computing system 102 generates a first prompt that includes a description of the query and selector information, the selector information including an instruction to select one or more functions from a group of functions, and a summary of the functions in the group of functions. In block 1208, the computing system 102 sends the first prompt to the machine-trained language model. In block 1310, the computing system 102 receives a first language-model response from the machine-trained language model that the machine-trained language model generates in response to the first prompt, the first language-model response including identification information that identifies a particular function specified in the group of functions. In block 1312, the computing system 102 generates a second prompt that provides a particular instance of function definition information that describes the particular function in more detail than the selector information in the first prompt by specifying at least input information to be provided to the particular function, the second prompt having fewer tokens than an amount of tokens that would be needed to describe all of the functions in the group of functions. In block 1314, the computing system 102 sends the second prompt to the machine-trained language model.

In block 1402 of FIG. 14, the computing system 102 receives a second language-model response that the machine-trained language model generates in response to the second prompt, the second language-model response providing (a) invocation information for invoking the particular function with input information that is formatted in a manner specified by the particular instance of function definition information, or (b) a message to provide additional information in a subsequent query for input to the particular function, to satisfy input-information requirements specified by the second prompt. In block 1404, for case (a), the computing system 102 invokes the particular function based on the invocation information. In block 1406, the computing system 102 generates final output information based on function-response information that has been produced thus far; alternatively, the computing system 102 produces another prompt that includes the function-response information produced in response to executing the particular function. The computing system 102 chooses one of these two paths based on information imparted in the second language-model response.

Although not shown in FIGS. 13 and 14, in some examples, the first prompt is preceded by a process that involves selecting a particular category among a set of categories. In some examples, the first prompt is also preceded by a process of choosing a particular subcategory associated with the particular category, among a set of subcategories.

### H. Computing Functionality

FIG. 15 shows computing equipment 1502 that, in some implementations, is used to implement the computing system 102. The computing equipment 1502 includes a set of local devices 1504 coupled to a set of servers 1506 via a computer network 1508. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1508 is implemented as a local area network, a wide area network (e.g., the Internet), one or more point-to-point links, or any combination thereof.

The bottom-most overlapping box in FIG. 15 indicates that the functionality of the computing system 102 is capable of being spread across the local devices 1504 and/or the servers 1506 in any manner. In one example, the computing system 102 is entirely implemented by a local device. In another example, the functions of the computing system 102 are entirely implemented by the servers 1506. Here, a user is able to interact with the servers 1506 via a browser application running on a local device. In other examples, some of the functions of the computing system 102 are implemented by a local device, and other functions of the computing system 102 are implemented by the servers 1506. In some implementations, for instance, the language model 104 is implemented by the servers 1506, and the remainder of the functions of the computing system 102 are implemented by each local device.

FIG. 16 shows a computing system 1602 that, in some implementations, is used to implement any aspect of the mechanisms set forth in the above-described figures. For instance, in some implementations, the type of computing system 1602 shown in FIG. 16 is used to implement any local computing device or any server shown in FIG. 15. In all cases, the computing system 1602 represents a physical and tangible processing mechanism.

The computing system 1602 includes a processing system 1604 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1602 also includes computer-readable storage media 1606, corresponding to one or more computer-readable media hardware units. The computer-readable storage media 1606 retains any kind of information 1608, such as machine-readable instructions, settings, model weights, and/or other data. In some implementations, the computer-readable storage media 1606 includes one or more solid-state devices, one or more hard disks, one or more optical disks, etc. Any instance of the computer-readable storage media 1606 uses any technology for storing and retrieving information. Further, any instance of the computer-readable storage media 1606 represents a fixed or removable unit of the computing system 1602. Further, any instance of the computer-readable storage media 1606 provides volatile and/or non-volatile retention of information. The specific term “computer-readable storage medium” or “storage device” expressly excludes propagated signals per se in transit, while including all other forms of computer-readable media; a computer-readable storage medium or storage device is “non-transitory” in this regard.

The computing system 1602 utilizes any instance of the computer-readable storage media 1606 in different ways. For example, in some implementations, any instance of the computer-readable storage media 1606 represents a hardware memory unit (such as random access memory (RAM)) for storing information during execution of a program by the computing system 1602, and/or a hardware storage unit (such as a hard disk) for retaining/archiving information on a more permanent basis. In the latter case, the computing system 1602 also includes one or more drive mechanisms 1610 (such as a hard drive mechanism) for storing and retrieving information from an instance of the computer-readable storage media 1606.

In some implementations, the computing system 1602 performs any of the functions described above when the processing system 1604 executes computer-readable instructions stored in any instance of the computer-readable storage media 1606. For instance, in some implementations, the computing system 1602 carries out computer-readable instructions to perform each block of the processes described with reference to FIGS. 12-14. FIG. 16 generally indicates that hardware logic circuitry 1612 includes any combination of the processing system 1604 and the computer-readable storage media 1606.

In addition, or alternatively, the processing system 1604 includes one or more other configurable logic units that perform operations using a collection of logic gates. For instance, in some implementations, the processing system 1604 includes a fixed configuration of hardware logic gates, e.g., that are created and set at the time of manufacture, and thereafter unalterable. In addition, or alternatively, the processing system 1604 includes a collection of programmable hardware logic gates that are set to perform different application-specific tasks. The latter category of devices includes programmable array logic devices (PALs), generic array logic devices (GALs), complex programmable logic devices (CPLDs), field-programmable gate arrays (FPGAs), etc. In these implementations, the processing system 1604 effectively incorporates a storage device that stores computer-readable instructions, insofar as the configurable logic units are configured to execute the instructions and therefore embody or store these instructions.

In some cases (e.g., in the case in which the computing system 1602 represents a user computing device), the computing system 1602 also includes an input/output interface 1614 for receiving various inputs (via input devices 1616), and for providing various outputs (via output devices 1618). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1620 and an associated graphical user interface presentation (GUI) 1622. The display device 1620 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1602 also includes one or more network interfaces 1624 for exchanging data with other devices via one or more communication conduits 1626. One or more communication buses 1628 communicatively couple the above-described units together.

The communication conduit(s) 1626 is implemented in any manner, e.g., by a local area computer network, a wide area computer network (e.g., the Internet), point-to-point connections, or any combination thereof. The communication conduit(s) 1626 include any combination of hardwired links, wireless links, routers, gateway functionality, name servers, etc., governed by any protocol or combination of protocols.

FIG. 16 shows the computing system 1602 as being composed of a discrete collection of separate units. In some cases, the collection of units corresponds to discrete hardware units provided in a computing device chassis having any form factor. FIG. 16 shows illustrative form factors in its bottom portion. In other cases, the computing system 1602 includes a hardware logic unit that integrates the functions of two or more of the units shown in FIG. 16. For instance, in some implementations, the computing system 1602 includes a system on a chip (SoC or SOC), corresponding to an integrated circuit that combines the functions of two or more of the units shown in FIG. 16.

The following summary provides a set of illustrative examples of the technology set forth herein.

(A1) According to one aspect, a method (e.g., the process 1302) is described for processing a query using a machine-trained language model (e.g., the language model 104). The method includes receiving (e.g., in block 1304) the query, and generating (e.g., in block 1306) a first prompt that includes a description of the query and selector information, the selector information including an instruction to select one or more functions from a group of functions, and a summary of the functions in the group of functions, and sending (e.g., in block 1308) the first prompt to the machine-trained language model. The method further includes receiving (e.g., in block 1310) a first language-model response from the machine-trained language model that the machine-trained language model generates in response to the first prompt, the first language-model response including identification information that identifies a particular function specified in the group of functions. The method further includes generating (e.g., in block 1312) a second prompt that provides a particular instance of function definition information that describes the particular function in more detail than the selector information in the first prompt by specifying at least input information to be provided to the particular function, the second prompt having fewer tokens than an amount of tokens that would be needed to describe all of the functions in the group of functions. The method further includes sending (e.g., in block 1314) the second prompt to the machine-trained language model, and receiving (e.g., in block 1402 of FIG. 14) a second language-model response that the machine-trained language model generates in response to the second prompt, the second language-model response providing invocation information for invoking the particular function with input information that is formatted in a manner specified by the particular instance of function definition information. The method further includes invoking (e.g., in block 1404) the particular function specified by the invocation information.

(A2) According to some implementations of the method of A1, the method further includes: receiving reference information that describes functions from at least one reference source; and using the machine-trained language model to transform the reference information into the selector information and instances of function definition information that describe the functions in the group of functions.

(A3) According to some implementations of the method of A1, the method further includes: receiving the selector information from a repository that includes different pre-generated instances of selector information; and receiving pre-generated instances of function description information from the repository that describe respective functions in the group of functions.

(A4) According to some implementations of any of the methods of A1-A3, the invocation information in the second language-model response is application programming interface information.

(A5) According to some implementations of any of the methods of A1-A4, the particular function is a first function, and the method further includes: receiving function-response information in response to invoking the first function; generating a third prompt that includes the selector information and the function-response information that is produced in response to invoking the first function; sending the third prompt to the machine-trained language model; receiving a third language-model response that the machine-trained language model generates in response to the third prompt, the third language-model response including identification information that identifies a second function specified in the group of functions; generating a fourth prompt that describes the second function in more detail than the selector information; sending the fourth prompt to the machine-trained language model; and receiving a fourth language-model response that the machine-trained language generates in response to the fourth prompt, the fourth language-model response providing invocation information for invoking the second function; and invoking the second function.

(A6) According to some implementations of any of the methods of A1-A5, the method further includes generating successive prompts and receiving successive language-model responses until a particular language-model response indicates that the particular language-model response is a final response.

(A7) According to some implementations of any of the methods of A1-A6, the method further includes, prior to sending the first prompt: sending an instance of first-level selector information to the machine-trained language model, the instance of first-level selector information specifying a set of categories, each category of the set of categories being associated with a subset of subcategories; and receiving a language-model response from the machine-trained language model that specifies a particular category, selected among the subset of categories.

(A8) According to some implementations of any of the methods of A1-A7, the identification information provided by the first language-model response specifies two or more of the functions from the group of functions, including the particular function, and the second language-model response provides invocation information for each of the two or more functions. The method further includes invoking the two or more functions in parallel.

(A9) According to some implementations of any of the methods of A1-A8, in processing performed for a subsequent query, in response to sending the second prompt to the machine-trained language model, receiving a message from the machine-trained language model that specifies that insufficient information has been received to satisfy input requirements of the particular function, as specified by the particular instance of function definition information.

(A10) According to some implementations of any of the methods of A1-A9, the method further includes automatically removing the particular instance of function definition information from a context data store upon a determination that a triggering event has occurred that indicates that the particular function definition information is no longer needed.

(A11) According to some implementations of the method of A10, one triggering event is an indication that the particular function associated with the particular instance of function information has been invoked.

(A12) According to some implementations of the methods of A10 or A11, one triggering event is an indication that another query has been received for which the particular function associated with the particular instance of function definition information is unusable.

(A13) According to some implementations of any of the methods of A1-A12, a first function in the group of functions receives input information generated by a second function in the group of functions, and two or more functions in the group of functions perform, at least in part, the same operations.

(A14) According to some implementations of any of the methods of A1-A13, the particular function is a computer program and/or or machine-trained model that accepts a particular input, performs particular operations on the input, and delivers a particular output as an outcome of the operations.

In yet another aspect, some implementations of the technology described herein include a computing system (e.g., the computing system 1602) that includes a processing system (e.g., the processing system 1604) having a processor. The computing system also includes a storage device (e.g., the computer-readable storage media 1606) for storing computer-readable instructions (e.g., the information 1608). The processing system executes the computer-readable instructions to perform any of the methods described herein (e.g., any individual method of the methods of A1-A14).

In yet another aspect, some implementations of the technology described herein include a computer-readable storage medium (e.g., the computer-readable storage media 1606) for storing computer-readable instructions (e.g., the information 1608). A processing system (e.g., the processing system 1604) executes the computer-readable instructions to perform any of the operations described herein (e.g., the operations in any individual method of the methods of A1-A14).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1612 of FIG. 16. The term “logic” likewise encompasses various physical and tangible mechanisms for performing a task. For instance, each processing-related operation illustrated in the flowcharts of FIGS. 12-14 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for processing a query using a machine-trained language model, comprising:
receiving the query;
generating a first prompt that includes a description of the query and selector information, the selector information including an instruction to select one or more functions from a group of functions, and a summary of the functions in the group of functions;
sending the first prompt to the machine-trained language model;
receiving a first language-model response from the machine-trained language model that the machine-trained language model generates in response to the first prompt, the first language-model response including identification information that identifies a particular function specified in the group of functions;
generating a second prompt that provides a particular instance of function definition information that describes the particular function in more detail than the selector information in the first prompt by specifying at least input information to be provided to the particular function, the second prompt having fewer tokens than an amount of tokens that would be needed to describe all of the functions in the group of functions;
sending the second prompt to the machine-trained language model;
receiving a second language-model response that the machine-trained language model generates in response to the second prompt, the second language-model response providing invocation information for invoking the particular function with input information that is formatted in a manner specified by the particular instance of function definition information; and
invoking the particular function specified by the invocation information.

2. The method of claim 1, further comprising:
receiving reference information that describes functions from at least one reference source; and
using the machine-trained language model to transform the reference information into the selector information and instances of function definition information that describe the functions in the group of functions.

3. The method of claim 1, further comprising:
receiving the selector information from a repository that includes different pre-generated instances of selector information; and
receiving pre-generated instances of function description information from the repository that describe respective functions in the group of functions.

4. The method of claim 1, wherein the invocation information in the second language-model response is application programming interface information.

5. The method of claim 1, wherein the particular function is a first function, the method further comprising:
receiving function-response information in response to invoking the first function;
generating a third prompt that includes the selector information and the function-response information that is produced in response to invoking the first function; and
sending the third prompt to the machine-trained language model;
receiving a third language-model response that the machine-trained language model generates in response to the third prompt, the third language-model response including identification information that identifies a second function specified in the group of functions;
generating a fourth prompt that describes the second function in more detail than the selector information;
sending the fourth prompt to the machine-trained language model;
receiving a fourth language-model response that the machine-trained language generates in response to the fourth prompt, the fourth language-model response providing invocation information for invoking the second function; and
invoking the second function.

6. The method of claim 1, further comprising generating successive prompts and receiving successive language-model responses until a particular language-model response indicates that the particular language-model response is a final response.

7. The method of claim 1, wherein the method further comprises:
prior to sending the first prompt, sending an instance of first-level selector information to the machine-trained language model,
the instance of first-level selector information specifying a set of categories, each category of the set of categories being associated with a subset of subcategories, and
receiving a language-model response from the machine-trained language model that specifies a particular category, selected among the subset of categories.

8. The method of claim 1,
wherein the identification information provided by the first language-model response specifies two or more of the functions from the group of functions, including the particular function,
wherein the second language-model response provides invocation information for each of the two or more functions, and
wherein the method comprises invoking the two or more functions in parallel.

9. The method of claim 1, further comprising, in processing performed for a subsequent query, in response to sending the second prompt to the machine-trained language model, receiving a message from the machine-trained language model that specifies that insufficient information has been received to satisfy input requirements of the particular function, as specified by the particular instance of function definition information.

10. The method of claim 1, further comprising automatically removing the particular instance of function definition information from a context data store upon a determination that a triggering event has occurred that indicates that the particular instance of function definition information is no longer needed.

11. The method of claim 10, wherein one triggering event is an indication that the particular function associated with the particular instance of function information has been invoked.

12. The method of claim 10, wherein one triggering event is an indication that another query has been received for which the particular function associated with the particular instance of function definition information is unusable.

13. The method of claim 1,
wherein a first function in the group of functions receives input information generated by a second function in the group of functions, and
wherein two or more functions in the group of functions perform, at least in part, the same operations.

14. The method of claim 1, wherein the particular function is a computer program and/or or machine-trained model that accepts a particular input, performs particular operations on the input, and delivers a particular output as an outcome of the operations.

15. A computing system for processing a query using a machine-trained language model, comprising:
an instruction data store for storing computer-readable instructions; and
a processing system for executing the computer-readable instructions in the data store, to perform operations including:
receiving the query;
in a first prompting operation, asking the machine-trained model to select a particular application programming interface (API) to be called in responding to the query, from a group of APIs;
receiving a first language-model response from the machine-trained language model that provides identification information that identifies the particular API in the group of APIs that is selected;
in a second prompting operation, asking the machine-trained language model to generate an API message to be input to the particular API that conforms to a particular instance of function definition information that describes the particular API, the second prompting operation producing fewer tokens than an amount of tokens that would be needed to describe all of the APIs in the group of APIs;
receiving a second language-model response that includes the API message that is generated, to be input to the particular API; and
sending the API message to the particular API to invoke the particular API.

16. The computing system of claim 15,
wherein the first prompting operation involves sending a first prompt to the machine-trained language model, the first prompt including a description of the query and selector information, the selector information including an instruction to select one or more APIs from the group of APIs, and a summary of the APIs in the group of APIs, and
wherein the second prompting operation involves sending a second prompt to the machine-trained language model that includes the particular instance of function definition information.

17. The computing system of claim 15, wherein the operations are repeated one or more times to invoke plural function calls in series.

18. The computing system of claim 15,
wherein the identification information provided by the first language-model response specifies two or more of the APIs from the group of APIs, including the particular API,
wherein the second language-model response provides an API message for each of the two or more APIs, and
wherein the operations further comprise invoking the two or more APIs in parallel.

19. The computing system of claim 18, wherein the operations further comprise automatically removing the particular instance of function definition information from a context data store upon a determination that a triggering event has occurred that indicates that the particular function definition information is no longer needed.

20. A computer-readable storage medium for storing computer-readable instructions, a processing system executing the computer-readable instructions to perform operations, the operations comprising each of:
receiving a query;
in response to the query, generating a prompt that describes a particular function based on a prior selection of the particular function by a machine-trained language model, the prompt having fewer tokens than an amount of tokens that would be needed to describe all functions in a group of functions from which the particular function was previously selected by the machine-trained language model,
the prompt including a particular instance of function definition information that describes at least input information to be provided to the particular function;
sending the prompt to the machine-trained language model; and
receiving a language-model response that the machine-trained language model generates in response to the prompt, the language-model response providing: (a) invocation information for invoking the particular function, the invocation information being formatted in accordance with the input information specified in the prompt; or (b) a message to provide additional information in a subsequent query for input to the particular function, to satisfy input-information requirements specified by the prompt.
